(19) United States
(12) Patent Application Publication
(10) Pub. No.: US 2014/0325450 A1
(43) Pub. Date: Oct. 30, 2014

(54) METHOD FOR EXECUTING APPLICATION, TERMINAL AND SERVER THEREOF

(71) Applicant: INFOBANK CORP., Seongnam-si (KR)

(72) Inventor: Jun ho JANG, Seongnam-si (KR)

(73) Assignee: INFOBANK CORP., Seongnam-si (KR)

(21) Appl. No.: 14/258,381

(22) Filed: Apr. 22, 2014

(30) Foreign Application Priority Data
Apr. 25, 2013 (KR) 10-2013-0046112
Apr. 26, 2013 (KR) 10-2013-0046877

(51) Int. Cl. G06F 3/0482

(52) U.S. Cl. CPC G06F 3/0482
USPC 715/838

(57) ABSTRACT

The present invention is related to a method for executing an application at a terminal such as a portable phone. The method for executing an application comprises capturing a screen being executed on an application, registering the captured screen together with user input information and displaying the captured screen as thumbnail images on a certain page of the application. And, the method for executing an application includes, when the displayed thumbnail images are selected, displaying the screen corresponding to the captured screen by using the registered user input information.

This application claims priority under 35 U.S.C. §119 to Korean Patent Application Nos. 10-2013-0046112 filed on Apr. 25, 2013, and 10-2013-0046877 filed on Apr. 26, 2013, which are both incorporated herein in their entirety.

### BACKGROUND OF THE INVENTION

1. Technical Field

The present invention relates to a method for executing an application at a terminal such as a portable phone.

2. Description of the Related Art

The terminal may be classified into a mobile terminal and a stationary terminal according to whether or not it is movable. Further, the mobile terminal may be classified into a handheld terminal and a vehicle mount terminal according to whether or not it may be directly carried by the user.

Services provided from the mobile terminal lately are becoming more diverse and therefore improving structural section and/or software section of the terminal is being considered.

With the development of an operating system for the terminal such as a smart phone, various applications may be disposed and executed at the terminal.

However, when prior terminals have various applications as above, there is a problem in that it is difficult for the user to grasp information for each application and therefore it is difficult to grasp whether using which application is the best to perform desired operations.

Further, the applications disposed in prior terminal have inconvenience that should perform many user input processes to perform the operations that the user wants.

For example, in case of a map application, position information of an wanted area should be inputted, after executing the application, to check traffic information for a specific area, it is possible to display a screen, that the user wants, by various steps such as reduction or expansion for map size. Therefore, there is a convenience that should repeat the processes for performing a series of existing input operations to check the traffic information for the same area.

### SUMMARY OF THE INVENTION

An advantage of some aspects of the invention is that it provides a method for executing an application, terminal and server thereof capable of improving the convenience of a terminal user.

According to an aspect of the invention, there is a provided a method for executing an application including capturing a screen of a first application being executed, registering the captured screen, together with identification information and user input information for the first application, into a second application, displaying the captured screen as thumbnail images on executing the second application, and executing the first application, when the displayed thumbnail images are selected, using the registered identification information and user input information and displaying the screen corresponding to the captured screen.

According to another aspect of the invention, there is a provided a server for transmitting an application to execute a method including capturing a screen of a first application being executed: registering the captured screen, together with identification information and user input information for the first application, into a second application; displaying the captured screen as thumbnail images on executing the second application; and executing the first application, when the displayed thumbnail images are selected, using the registered identification information and user input information and displaying the screen corresponding to the captured screen.

According to further another aspect of the invention, there is a provided a terminal including a display section for displaying a screen of an application; and a controller capturing a screen of a first application being executed, registering the captured screen, together with identification information and user input information for the first application, into a second application, displaying the captured screen as thumbnail images on executing the second application, and executing the first application, when the displayed specific thumbnail images are selected, using the registered identification information and user input information and displaying the screen corresponding to the captured screen.

According to further another aspect of the invention, there is a provided a method for executing an application including capturing a screen being executed on an application; registering the captured screen together with user input information; displaying the captured screen as thumbnail images on a certain page of the application; and displaying the screen corresponding to the captured screen, when the displayed specific thumbnail images are selected, using the registered user input information.

According to further another aspect of the invention, there is a provided a server for transmitting an application to execute a method including capturing a screen being executed on an application; registering the captured screen together with user input information; displaying the captured screen as thumbnail images on a certain page of the application; and displaying the screen corresponding to the captured screen, when the displayed specific thumbnail images are selected, using the registered user input information.

According to further another aspect of the invention, there is a provided a terminal including an output section displaying a screen of an application; and a controller for capturing the screen being executed, registering the captured screen together with user input information, displaying the captured screen as thumbnail images on executing the application, and displaying the screen corresponding to the captured screen, when the displayed specific thumbnail images are selected, using the registered user input information.

On the other hand, the method for executing an application may be implemented by a computer-readable recording medium for recording programs to enable computer to execute.

### BRIEF DESCRIPTION OF THE DRAWINGS

The following drawing drawings attached to the present specification illustrate an exemplary embodiment of the invention, and serves to further understand the technical idea of the invention along with a detailed description of the invention. Therefore, the invention is not limited to matters described in the drawings.

FIG. 1 is a block view for representing configurations of a terminal related to one embodiment of the present invention.

FIG. 2 is a flow chart for representing an application execution method according to one embodiment of the present invention.

FIG. 3 to FIG. 7 show examples for operations of an application according to a user input.

FIG. 8 to FIG. 10 show examples for methods for automatically performing executing and input processes of the application using captured screen of the application.

FIG. 11 shows one example for configurations of an initial screen of the application.

FIG. 12 to FIG. 16 are views for describing the application execution method according to another embodiment of the present invention.

### DESCRIPTION OF THE PREFERRED EMBODIMENTS

Hereinafter, an exemplary embodiment of the disclosure will be described in detail with reference to drawings. However, the disclosure cannot be limited to the embodiment in which the idea of the disclosure is presented, another embodiment included within range of idea of another backward disclosure or the closure may be easily proposed by addition, change, deletion and the like of another constituent.

Hereinafter, an application execution method, and a terminal and server using the same will be described with reference to the attached drawings according to the embodiments of the present invention.

Various features and advantages of the present invention will be more obvious from the following description with reference to the accompanying drawings. Hereinafter, embodiments of the invention will be described with reference to the attached drawings. Like reference numerals denote like elements throughout the specification. In describing exemplary embodiments of the present invention, well-known functions or constructions will not be described in detail since they may unnecessarily obscure the understanding of the present invention.

Hereinafter, a mobile terminal related to the present invention will be described in more detail with reference to drawings. Suffix “module” and “section” for the configurations used in the following description are given or mixed for the easiness of specification writing, and they have no meanings or roles distinguished from each other.

The terminal described in the present specification may be included with a portable phone, a smart phone, a laptop computer, a terminal for digital broadcasting, a PDA (Personal Digital Assistants), a PMP (Portable Multimedia Player), a navigation system, etc., but the present invention is not limited thereto and may be various apparatuses performing a user input and information display, etc.

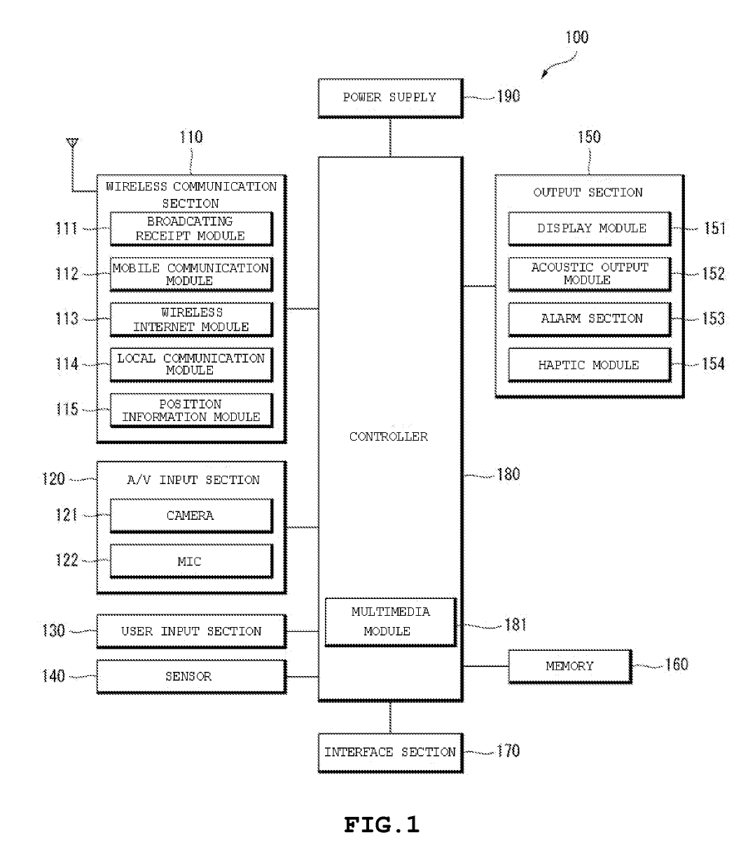

FIG. 1 is a block view for representing configurations of a terminal related to one embodiment of the present invention. In FIG. 1, a mobile terminal 100 includes a wireless communication section 110, an A/V (Audio/Video) input section 120, a user input section 130, a sensor 140, an output section 150, a memory 160, an interface section 170, a controller 180, and a power supply 190, etc. The configurations shown in FIG. 1 are not necessary, and therefore the mobile terminal may have configurations more or less than the configurations shown in FIG. 1.

Hereinafter, the configurations are described in turn.

The wireless communication section 110 may include at least one module that may perform the wireless communication between the mobile terminal 100 and a wireless communication system or between the mobile terminal 100 and a network in which the mobile terminal 100 is located. For example, the wireless communication section 110 may include a broadcasting receipt module 111, a mobile communication module 112, a wireless internet module 113, a local communication module 114 and a position information module 115, etc.

The broadcasting receipt module 111 receives broadcasting signal and/or broadcasting-related information from an exterior broadcasting management server through broadcasting channels.

The broadcasting channels may include satellite channels and terrestrial channels. The broadcasting management server generates and transmits the broadcasting signals and/or broadcasting-related information or receives the broadcasting signals and/or broadcasting-related information generated already and transmits them to the terminal. The broadcasting signals include TV broadcasting signals, radio broadcasting signals, data broadcasting signals and may also include broadcasting signal types coupling data broadcasting signals with TV broadcasting signals and radio broadcasting signals.

The broadcasting-related information may mean broadcasting channels, broadcasting programs or broadcasting service provider-related information. The broadcasting-related information may be also provided through mobile communication networks. In such a case, it may be received by the mobile communication module 112.

The broadcasting-related information may be present as various types. For example, it may be present as the types such as EPG (Electronic Program Guide) of DMB (Digital Multimedia Broadcasting) or ESG (Electronic Service Guide) of DVB-H (Digital Video Broadcast-Handheld).

The broadcasting receipt module 111 receives broadcasting signals using various broadcasting systems, and particularly receives digital broadcasting signals using digital broadcasting systems such as DMB-T (Digital Multimedia Broadcasting-Terrestrial), DMB-S (Digital Multimedia Broadcasting-Satellite), MediaFLO (Media Forward Link Only), DVB-H (Digital Video Broadcast-Handheld), ISDB-T (Integrated Services Digital Broadcast-Terrestrial). In addition, the broadcasting receipt module 111 may be configured to suit for the above-described digital broadcasting systems and anther broadcasting systems providing the broadcasting signals.

The broadcasting signals and/or broadcasting-related information received through the broadcasting receipt module 111 may be stored into a memory 160.

The mobile communication module 112 transmits/receives wireless signals from/in at least one of base stations, an exterior terminal and servers on the mobile communication networks. The wireless signals may include voice call signals, video communication signals or data having various types according to transmission/receipt of characters/multimedia messages.

The wireless internet module 113, which is a module for wireless internet connection, may be internal or external to the mobile terminal 100. WLAN (Wireless LAN) (Wi-Fi), Wibro (Wireless broadband), Wimax (World Interoperability for Microwave Access), HSDPA (High Speed Downlink Packet Access), etc. may be used as wireless Internet technologies.

The local communication module 114 is a module for the local communication. Bluetooth, RFID (Radio Frequency Identification), IrDA (Infrared Data Association), UWB (Ultra Wideband), ZigBee, etc. may be used as the local communication technologies.

The position information module 115 is a module for checking and acquiring a position of the mobile terminal. The position information module 115 may acquire position information using GNSS (Global Navigation Satellite System). Wherein, the GNSS that revolves Earth is a wireless navigation satellite system in which a predetermined type of a wireless navigation receivers sends reference signals that may determine positions of them on the surface of the earth or near the same. Examples of the GNSS are Global Position System that operates in U.S.A, Galileo that operates in European, GLONASS (Global Orbiting Navigational Satellite System) that operates in Russia, COMPASS that operates in China, and QZSS (Quasi-Zenith Satellite System) that operates in Japanese.

In the GNSS, the position information module 115 may be a GPS (Global Position System) module. The GPS module calculates information for a distance from one point (individual) to at least three satellites and information for time measuring the distance information, applies trigonometry to the calculated distance information, and may calculate three dimensional position information configured with latitude, longitude and altitude for one point (individual) at one time. Further, the position and time information are calculated by three satellites, or errors for the calculated position and time information are corrected by another one satellite. The GPS module continuously calculates current positions in real time and calculates velocity information using them.

Referring to FIG. 1, A/V (Audio/Video) input section 120 for inputting audio signals or video signals includes a camera 121 and a microphone 122, etc. The camera 121 processes video frames such as still images or moving pictures, etc. acquired by an image sensor at the video communication mode or photographing mode. The processed video frames are displayed on a display module 151.

The video frames processed at the camera 121 are stored into a memory 160 or may be transmitted outside through the wireless communication section 110. The camera 121 may be configured with at least two according to configuration types of the terminal.

The microphone 122 receives exterior acoustic signals by the microphone at the communication mode or recording mode, voice recognition node, etc. and processes the received signals into electrical voice data. The processed voice data may be converted in a transmissible type and outputted to a mobile communication base station through the mobile communication module 112 in case of the communication mode. The microphone 122 may be implemented with various noises removing algorithm for removing noise caused on receiving exterior acoustic signals.

The user input section 130 generates input data for controlling operations of the terminal by the user. The user input section 130 may be configured with a key pad, a dome switch, a touch pad (static pressure type/electrostatic type), a jog wheel, a jog switch, etc.

The sensing section 140 senses a current state of the mobile terminal 100 such as an opening and closing state of the mobile terminal 100, a position of the mobile terminal 100, a user touch or not, an azimuth of the mobile terminal, and acceleration/reduction of speed of the mobile terminal and therefore generates sensing signals for controlling operations of the mobile terminal 100. For example, when the mobile terminal 100 is a slide phone type, it senses an opening/closing or not of the slide phone. In addition, it may be in charge of sensing functions related to power supply or not of the power supply 190 and an exterior equipment coupling or not of the interface section 170, etc. On the other hand, the sensor 140 may include a proximity sensor.

The output section 150 for generating outputs related to vision, hearing, touch sensation, etc. may include a display module 151, an acoustic output module 152, an alarm section 153 and a haptic module 154, etc.

The display module 151 displays information processed by the mobile terminal 100. For example, the mobile terminal displays UI (User Interface) or GUI (Graphic User Interface) related to communication at the communication mode. The mobile terminal 100 displays photographed or received images or UI, GUI at the video communication mode or photographing mode.

The display module 151 according to the embodiment of the present invention displays the screen of the application.

The display module 151 may include at least one of liquid crystal display, thin film transistor-liquid crystal display), organic light-emitting diode, flexible display and 3D display.

Some displays among them may be configured with a transparent type or a photo-transmission type that may see the outside through them. They are called a transparent display, and a representative example of the transparent display is a transparent LCD, etc. The rear structure of the display module 151 may be also configured with a photo-transmission structure. With such a structure, the user may see objects at the rear of the terminal body through the regions occupied by the display module 151 of the terminal body.

The display module 151 may be more than two according to an implement type of the mobile terminal 100. For example, the mobile terminal 100 may be disposed with a plurality of display modules 151 spaced by one face or integrally, or they may be disposed at faces different from each other.

When the display module 151 and the sensor (hereinafter, called “touch sensor”) for sensing touch operations form mutual layer structures, the display module 151 may be used as input devices besides the output devices. The touch sensor may have types such as, for example, touch films, touch sheets, touch pads.

The touch sensor converts changes for pressures applied or capacitance generated to the specific parts of the display module 151 into electrical input signals. The touch sensor may detect positions and areas to be touched and the pressures to be touched.

When there are touch inputs for the touch sensors, signals corresponding to the touch inputs are sent to a touch controller. The touch controller processes the signals and then transmits data corresponding to the processed signals to the controller 180. Therefore, the controller 180 may know whether which regions of the display module 151 are touched.

Referring to FIG. 1, the proximity sensor may be disposed in an internal region of the mobile terminal wrapped by the touch screen or near the touch screen. The proximity sensor is the sensor for detecting whether objects approaching certain detecting faces or the objects that exist near it are present or not using the power of electric and magnetic fields or infrared rays without mechanical touches. The proximity sensor has a long life and high availability as compared with a touch sensor.

The examples for the proximity sensor are a transparent optical electric sensor, a direct reflective optical electric sensor, a mirror reflective optical electric sensor, a high-frequency oscillation-type proximity sensor, a capacitance-type proximity sensor, a magnetic proximity sensor, and an infrared ray proximity sensor, etc.

The touch screen detects approach of the pointer by changes of an electric field according to the approach of the pointer in case of a capacitive type. In this case, the touch screen (a touch sensor) may be sorted into the proximity sensor.

Hereinafter, for your convenience for the description, actions to be recognized so that the pointer is not contacted on the touch screen and is approached to it and therefore the pointer is located on the touch screen are called “proximity touch”, and actions to be performed so that the pointer is actually contacted on the touch screen are called “contact touch”. The position to be closely touched by the pointer on the touch screen means the position that the pointer is vertically corresponded to the touch screen when the pointer is closely touched.

The proximity sensor senses a proximity touch and proximity touch pattern (example, a proximity touch distance, a proximity touch direction, a proximity touch time, a proximity touch position, a proximity touch movement state, etc.). Information corresponding to The sensed proximity touch operations and the proximity touch pattern may be outputted on the touch screen.

The acoustic output module 152 receives call signals from the wireless communication section 110 at the communication mode or recording mode, voice recognition mode and broadcasting receipt mode, etc. or outputs audio data stored into the memory 160. The acoustic output module 152 outputs the acoustic signals related to the functions (for example, call signal ringtone, message ringtone, etc.) performed at the mobile terminals 100. Such a acoustic output module 152 may be included with a receiver, a speaker, a buzzer, etc. In addition, the acoustic output module 152 may output the acoustics through an earphone-jack 116. The user connects the earphone to the earphone-jack 116 and therefore may listen the acoustics to be outputted.

The alarm section 153 outputs the signals informing event generations of the mobile terminal 100. The examples of the events generated at the mobile terminal are call signal receipt, message receipt, key signal input, touch input, etc. The alarm section 153 may output different types, except video signals or audio signals, for example, the signals informing event generations by vibration. The video signals or audio signals may be also outputted through the display module 151 or the acoustic output module 152.

The haptic module 154 generates various tactile sensation effects that may be sensed by the user. A representative example of the tactile sensation effects generated by the haptic module 154 is the vibration. It is possible to control the intensity and pattern, etc. of the vibration generated by the haptic module 154. For example, It is possible to mix the vibrations different from each other and output them or sequentially output them.

The haptic module 154 may generate various tactile sensation effects such as an effect due to stimulus caused by pin arrays vertically moving for a contacting skin face, an effect due to the stimulus through jet force or suction force of air by a nozzle or inlet, an effect due to the stimulus grazing a skin surface, an effect due to the stimulus through the contact of an electrode, an effect due to the stimulus using electrostatic force, an effect due to thermal feedback reappearance using an element capable of performing heat absorption or heating, etc., except the vibration.

The haptic module 154 may transfer tactile sensation effects through direct contact and enables muscle sense such as fingers or arms of the user to sense the tactile sensation effects. The haptic module 154 may be at least two according to the configuration types of the mobile terminal 100.

The memory 160 may store the programs for operating the controller 180, may temporarily store data (for example, phone books, messages, still images and moving pictures, etc.) to be inputted. The memory 160 may store data related to the vibration and acoustic of various patterns to be outputted on doing touch input on the touch screen.

The memory 160 may include at least one storage medium type of a flash memory type, a hard disk type, a multimedia card micro type, a card type of memory (for example, SD or XD memory, etc.), a RAM (Random Access Memory), a SRAM (Static Random Access Memory), a ROM (Read-Only Memory), a EEPROM (Electrically Erasable Programmable Read-Only Memory), a PROM (Programmable Read-Only Memory) magnetic memory, a magnetic disk and a photo disk. The mobile terminal 100 may operate in relation to web storage for performing storage functions of the memory 160 on an internet.

The interface section 170 functions as passages for all exterior equipments connected to the mobile terminal 100. The interface section 170 receives data from exterior equipments or receives power supply, transfers the received data to each configuration inside the mobile terminal 100 or transmits data inside the mobile terminal 100 to the exterior equipments. For example, the interface section 170 may include a wire/wireless headset port, an exterior charger port, a wire/wireless data port, a memory card port, a port connecting a device disposed with an identification module, an audio I/O (Input/Output) port, a video I/O (Input/Output) port, an earphone port, etc.

The identification module, which is a chip storing various information for authenticating usable authority for the mobile terminal 100, may include a UIM (User Identify Module), a SIM (Subscriber Identify Module), a USIM (Universal Subscriber Identity Module), etc. The device (hereinafter, ‘an identification device’) disposed with the identification module may be made as a smart card type. Therefore, the identification device may be connected to the terminal 100 through a port.

The interface section 170 may become the passage for supplying power supply from a cradle to the mobile terminal 100 on connecting the mobile terminal 100 to an exterior cradle, and may become the passage for transferring various command signals inputted from the cradle by the user to the mobile terminal. Various command signals and the power supply inputted from the cradle may be operated by the signals for recognizing accurate mounting of the mobile terminal for the cradle.

The controller 180 typically controls the whole operations of the mobile terminal. For example, it controls and processes voice communication, data communication, video communication, etc. The controller 180 may include a multimedia module 181 for reproducing multimedia. The multimedia module 181 may be implemented in the controller 180, and may be separately implemented for the controller 180.

The controller 180 processes pattern recognition that may recognize writing inputs or painting inputs performed on the touch screen as each character and image.

The controller 180 captures a screen being executed on applications, registers the captured screen together with a user input information, displays the captured screen as thumbnail images on executing the application, and displays the screen corresponding to the captured screen when the displayed thumbnail images are selected, using the registered user input information in the embodiment of the present invention.

Wherein, the user input information includes information for sequential inputs requested from the user in the interval from executing of the application to displaying of the captured screen, and the screen corresponding to the captured screen updates the captured screen according to the related information at this time.

The power supply 190 receives an exterior power and an internal power by control of the controller 180 and supplies power necessary for operations of each configuration.

Various embodiments described in the present application, for example, may be implemented using software, hardware or the combination of both in a computer or a recording medium that is readable by the device similar to the same.

With hardware implementation, the embodiment described in the present application may be implemented using at least one of ASICs (application specific integrated circuits), DSPs (digital signal processors), DSPDs (digital signal processing devices), PLDs (programmable logic devices), FPGAs (field programmable gate arrays, processors, controllers, micro-controllers) and microprocessors. In some cases, such embodiments may be implemented by a controller 180.

With software implementation, the embodiments such as procedures or functions may be implemented together with separate software modules performing at least one function or operation. A software code may be implemented by a software application written by suitable program languages. Further, the software code is stored into the memory 160, and may be executed by the controller 180.

According to an embodiment of the present invention, executing and input processes of the application may be automatically implemented using a captured screen of the application executed already, thereby to enhance the convenience of an application user.

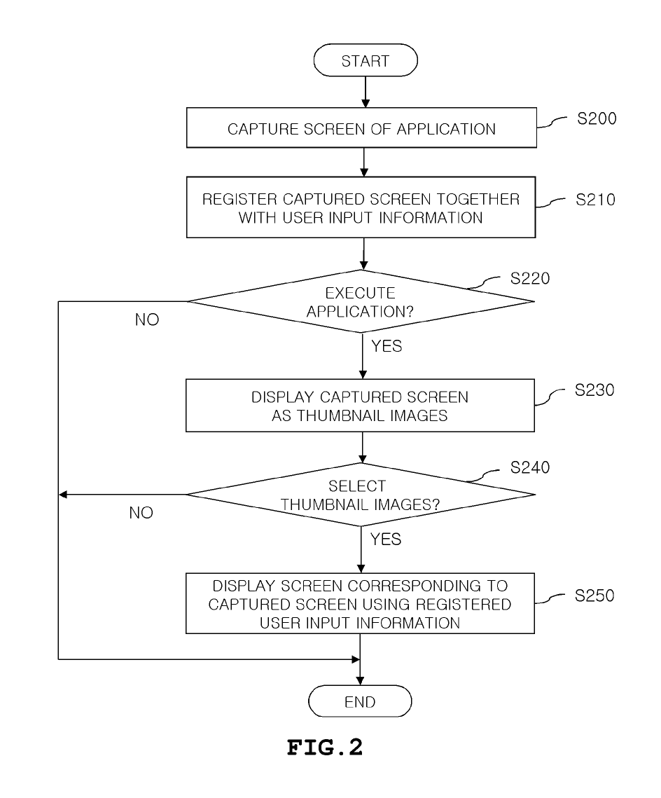

FIG. 2 is a flow chart for representing an application execution method according to one embodiment of the present invention, and the application execution method will be described in relation to a block view for representing the configurations of the terminal according to one embodiment of the present invention shown in FIG. 1.

Referring to FIG. 2, the controller 180 captures the screen on the application being executed in response to the request of the user recognized through the user input section 130 or the sensor 140 and therefore stores the captured screen into the memory 160 (step S200).

The application may be any one of the application, providing various functions, such as map, Internet, mail, messenger, navigation, etc., and the present invention is not limited to the application having the specific functions.

Then, the controller 180 registers the captured screen together with the user input information to be inputted on moving the captured screen from the application to the screen (step S210).

The user input information, which is information for a series of input operations of the user to display the captured screen, may include input information necessary to form the captured screen on executing the application later.

For example, the user input information may include sequential inputs, for example, inputs such as key inputs, characters, numbers or symbols, and selection of the specific objects using the touch, requested from the user in the interval from executing of the application to displaying of the captured screen.

When the application is executed (step S220), the controller 180 controls the display module 151 to display the captured screen as the thumbnail images (step S230).

The screen of the application may be displayed with a plurality of thumbnail images including the thumbnail images of the captured screen, and the plurality of thumbnail images may be corresponded to each of the specific user inputs.

Then, when the displayed thumbnail images are selected from the user through the user input section 130 (step S240), it displays the screen corresponding to the captured screen using the registered user input information (step S250).

The screen displayed at step S250 may be one that updates previously captured screen according to the related information at this time.

For example, when the application is the application providing map information, the controller 180 may update and display previously captured screen according to current traffic information.

In the present invention, the functions of the controller 180 and the display module 150 may be included in the function of at least one application, and the controller 180 and the display module 150 may be included on the application in a program type.

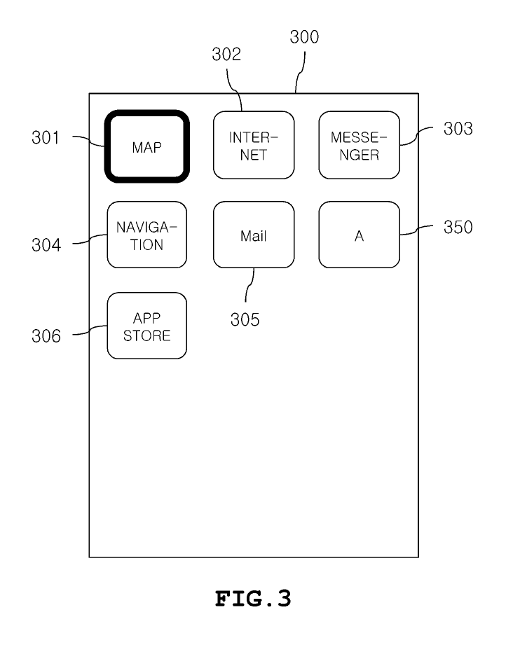

Hereinafter, the embodiments for the application execution method according to the present invention will be described with reference to FIG. 3 to FIG. 12.

FIG. 3 to FIG. 7 show examples for operations of an application according to a user input.

Referring to FIG. 3, the terminal 100 may be disposed with a plurality of applications downloaded from the server for providing the application.

For example, a map application, an internet application, a messenger application, a navigation application, a mail application, and “A” application disposed at the terminal 100 may be the applications downloaded from the server through a App Store application.

The icons 301 to 306, 350 each corresponding to the applications disposed as above are displayed on the screen 300 of the terminal 100.

The server according to one embodiment of the present invention may transmit the application for performing the application execution method according to one embodiment of the present invention to the terminal 100 by request of the user.

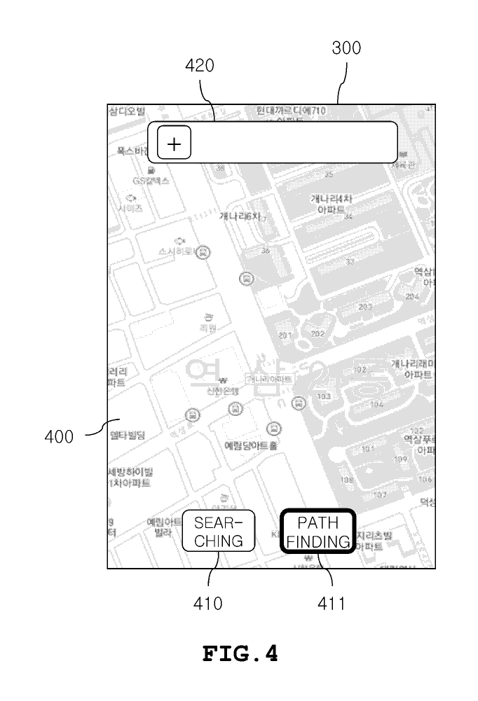

For example, when the user selects a first icon 301 corresponding to the map application, the map application is executed and the map application screen may be displayed as shown in FIG. 4.

In the screen, the user selects a search button 410, inputs positions to be searched to a search word input window 420 or selects a path finding button 411 and inputs a starting point and a destination, thereby to find moving paths.

On the other hand, the screen may be displayed with a map 400 corresponding to a current position.

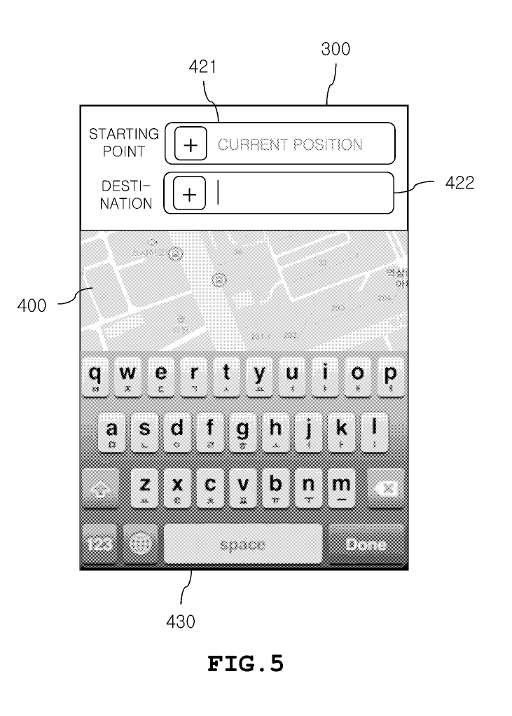

When the user selects the path finding button 411, a starting point input window 421 and a destination input window 422 are displayed on the screen 300 as shown in FIG. 5 and may be displayed together with a key input window 430 inputting characters or numbers, etc. to input windows 421, 422 by the user.

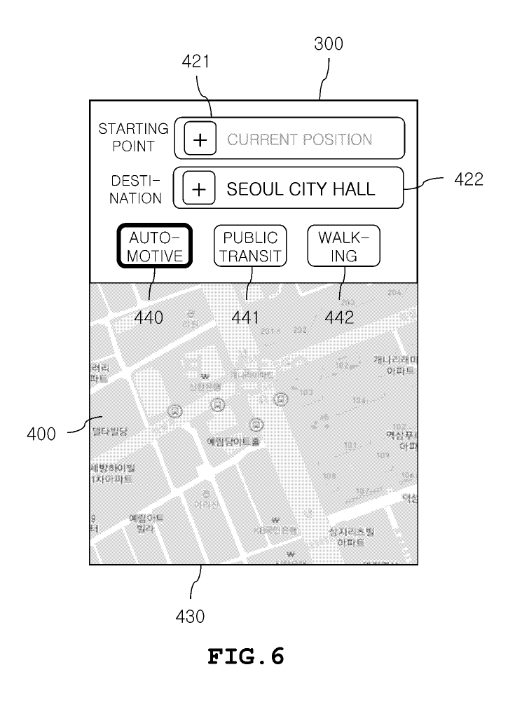

Referring to FIG. 6, the user inputs the starting point and the destination using the key input window 430, selects any one of buttons 440, 441, 422 representing moving means and may execute the path finding.

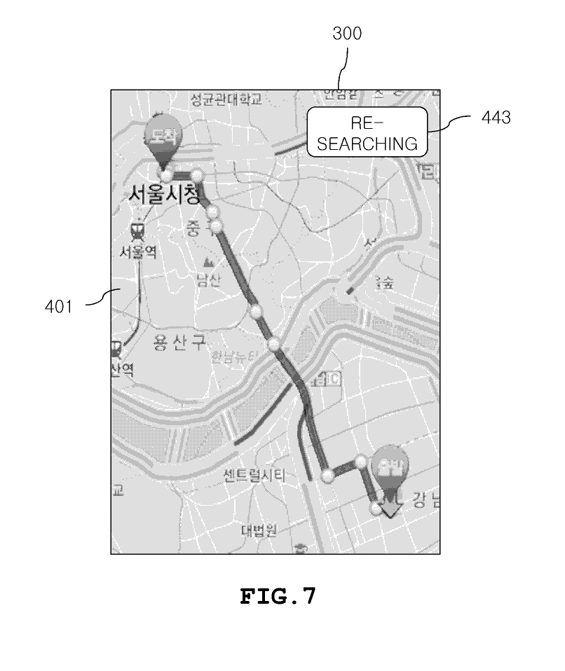

When the inputs are sequentially inputted, a map 401 representing the moving path according to the inputted starting point and destination may be displayed on the screen 300 as shown FIG. 7.

On the other hand, the traffic information may be displayed on the map 401, and for example, each road may be displayed as colors different from each other according to the traffic.

The user selects a researching button 443 and may research the moving path according to the starting point and destination.

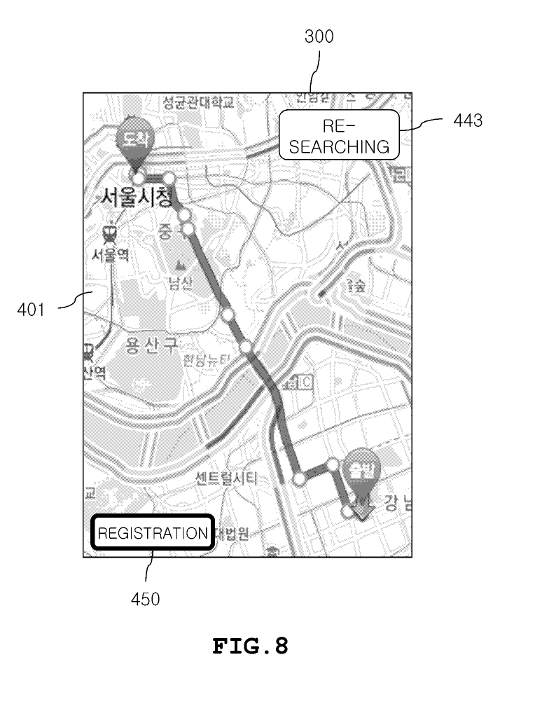

FIG. 8 to FIG. 10 show examples for a method for automatically performing executing and input processes of the application using captured screen of the application.

As shown in FIG. 8 according to one embodiment of the present invention, the screen of the map application displayed by sequential inputs of the user may be displayed with a “registration” button 450 capturing the corresponding screen and registering into the map application.

In the situation as shown in FIG. 8, when the user selects the “registration” button 450, the screen shown in FIG. 8 is captured and is stored into the memory 160, and the corresponding captured screen is registered into the map application.

On the other hand, the captured screen is stored together with information for sequential inputs of the user until the corresponding screen is displayed and may be registered into the map application.

For example, the user input information includes information for a series of operations inputted from the user from executing of the map application to displaying of the captured screen, and may include sequential input information such as selection of the path finding button 411, inputting of “Seoul City Hall” to the destination input window 422 using the key pad 430, and selection of an automobile button 440 in the case shown in FIG. 8.

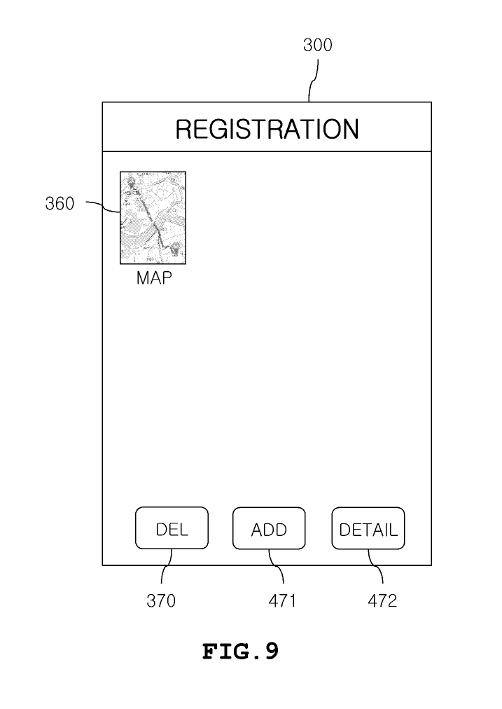

As above, after the screen of the map application is captured and the captured screen is registered into the map application, when the user selects the icon 301 corresponding to the map application from the screen 300 shown in FIG. 3 and executes the map application, a thumbnail image 360 that reduces a previously captured registered screen may be displayed as shown in FIG. 9.

On the other hand, the screen 300 of the map application 351 may be displayed with a deletion button 370 for deleting the registered capture screen, an addition button 471 for additively registering newly captured screen, and a detail information button 472 for checking detail information for the selected captured screen.

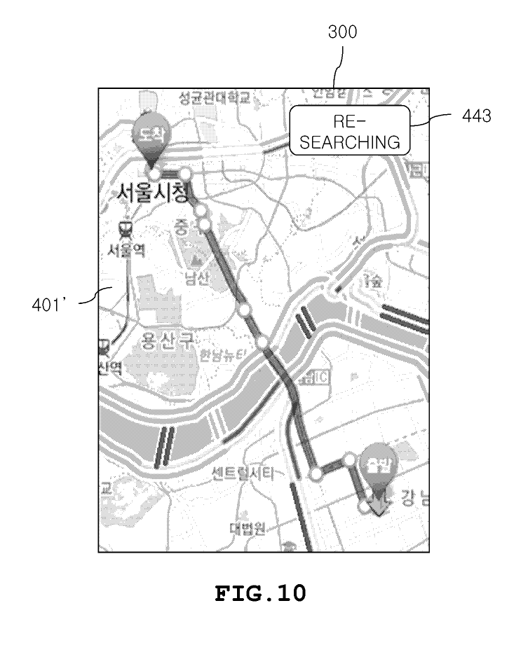

When the user selects the thumbnail image 360 displayed on the screen 300 of the map application, the functions of the map application are automatically executed using the corresponding captured screen and user input information and the screen 401′ corresponding to the captured screen may be displayed as shown in FIG. 10.

That is, the controller 180 sequentially performs a series of user input operations stored to be corresponded to the selected thumbnail image, that is, selection of the path finding button 411, inputting of “Seoul City Hall” to the destination input window 422 using the key pad 430, and selection of an automobile button 440, and therefore the screen 401′ corresponding to the captured screen may be displayed.

The screen 401′ may be the same screen as previously captured screen, but it is replaced with the screen updated according to current map-related information when ever-changing information such as traffic information is included.

For example, the map screen 401 shown in FIG. 8 and the map screen 401′ shown in FIG. 10 are maps for the same region, but the traffic information is updated at this time and may be displayed differently from the past.

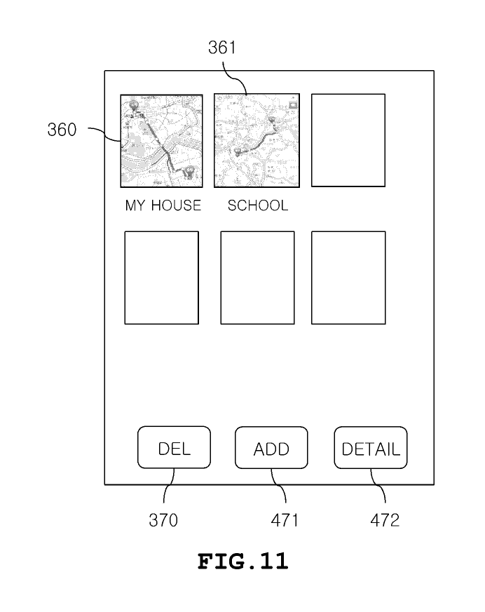

Referring to FIG. 11, when a method described with reference to FIG. 2 to FIG. 10 is used and the captured screens registered into the map application may be multiple, a certain screen of the map application may be displayed with thumbnail images 360, 361, etc. corresponding to each of the captured screen.

“My house” thumbnail image 360 and “school” thumbnail image 361 are the screens to be captured on executing the same map application, but the captured time or a series of user input operations may be different from each other.

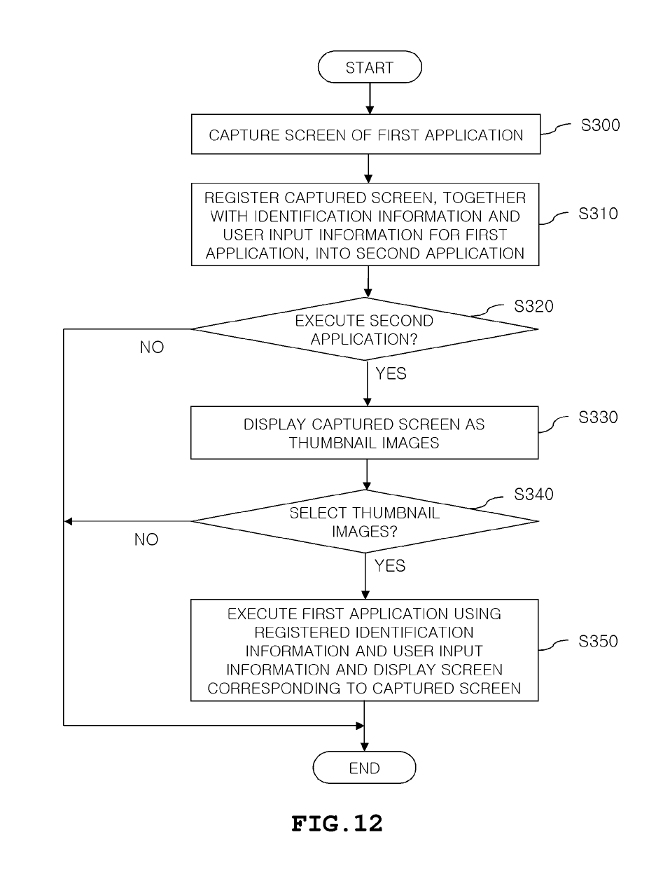

FIG. 12 shows a flow chart for an application execution method according to another embodiment of the present invention.

Referring to FIG. 12, the controller 180 captures the screen of the application being executed in response to the request of the user recognized through the user input section 130 or the sensor 140 and therefore stores the captured screen into the memory 160 (step S300).

The first application may be any one of the applications, providing various functions, such as map, Internet, mail, messenger, navigation, etc., and the present invention is not limited to the applications having the specific functions.

Then, the controller 180 registers the captured screen, together with the identification information and user input information for the first application, into a second application (step S310).

The second application may be the application, disposed in the terminal 100, for performing the application execution method according to one embodiment of the present invention, but the second application may have various functions besides the application execution method according to one embodiment of the present invention.

The identification information for the first application may mean information necessary to execute the first application later, and may include, for example, any one of a name of the first application, an application server address and manufacturer information.

In addition, the user input information, which is information for a series of input operations of the user to display the captured screen, may include input information necessary to form the captured screen on executing the first application later.

For example, the user input information may include sequential inputs, for example, inputs such as key inputs, characters, numbers or symbols, and selection of the specific objects using the touch, requested from the user in the interval from executing of the first application to displaying of the captured screen.

When the second application is executed (step S320), the controller 180 controls the display module 151 to display the captured screen as the thumbnail images (step S330).

The screen of the second application may be displayed with a plurality of thumbnail images including the thumbnail images of the captured screen for the first application, and the plurality of thumbnail images may be corresponded to each of the specific applications and the specific user inputs.

Then, when the displayed thumbnail images are selected from the user through the user input section 130 (step S340), it executes the first application using the registered identification information and user input information and displays the screen corresponding to the captured screen (step S250).

The screen displayed at step S250 may be one that updates previously captured screen according to the related information at this time.

For example, when the first application is the application providing map information, the controller 180 may update and display previously captured screen according to current traffic information.

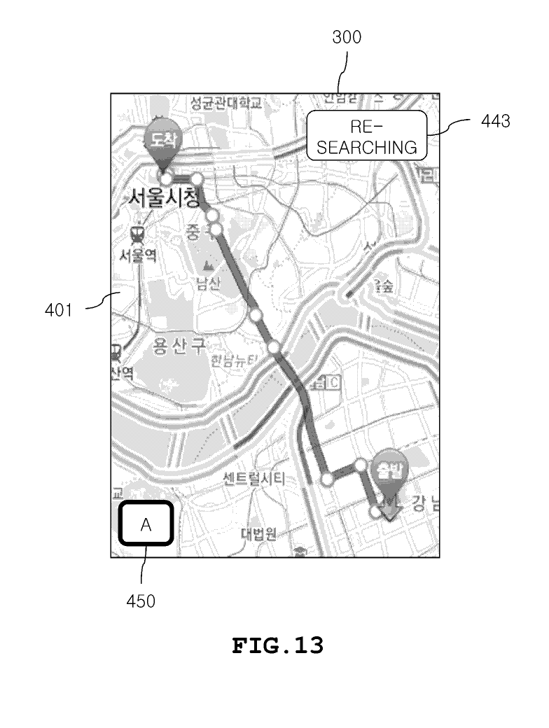

FIG. 13 to FIG. 16 shows examples for a method for automatically performing execution and input processes of the application using captured screens of the application.

As shown in FIG. 13 according to one embodiment of the present invention, the screen of the map application displayed by sequential inputs of the user may be displayed with a “A” button 450 capturing the corresponding screen and registering the captured screen into a “A” application.

When the user selects the “A” button 450 in the situation as shown in FIG. 13, the screen shown in FIG. 13 is captured and the captured screen is stored into the memory 160, and the corresponding captured screen is registered into the “A” application.

On the other hand, the captured screen is stored together with information for the sequential inputs of the user until the identification information and the corresponding screen for the map application are displayed.

For example, the identification information is information necessary to execute the map application later, and may include, in more detail, any one of the name of the map application, the application server address and the manufacturer information.

In addition, the user input information includes information for a series of operations inputted from the user from executing of the map application to displaying of the captured screen, and may include sequential input information such as selection of the path finding button 411, inputting of “Seoul City Hall” to the destination input window 422 using the key pad 430, and selection of an automobile button 440 as shown in FIG. 4 to FIG. 6.

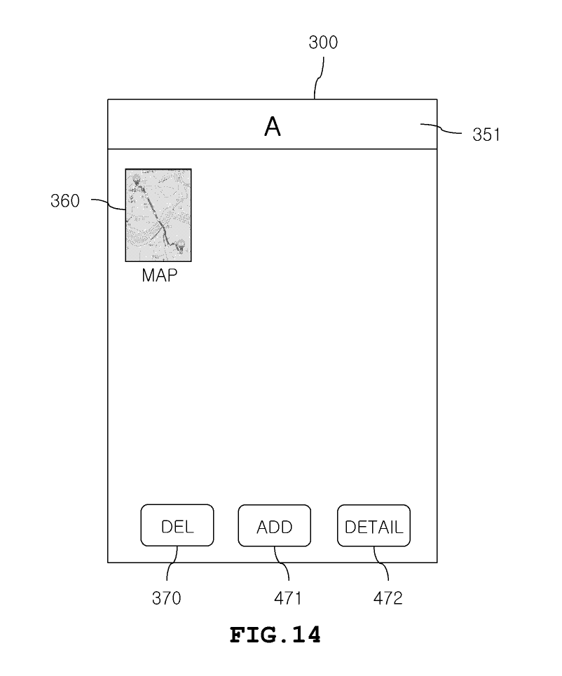

As above, after the screen of the map application is captured and the captured screen is registered into the “A” application, when the user selects the icon 350 corresponding to the “A” application from the screen 300 shown in FIG. 3 and executes the “A” application, the thumbnail image 360 that reduces a previously captured registered screen may be displayed as shown in FIG. 14.

On the other hand, the screen 300 of the “A” application 351 may be displayed with a deletion button 370 for deleting the registered captured screen, an addition button 471 for additively registering newly captured screen, and a detail information button 472 for checking detail information for the selected captured screen.

When the user selects the thumbnail image 360 displayed on the screen 300 of the “A” application 351, the map application is automatically executed using the application identification information and user input information registered together with the corresponding captured screen and the screen 401′ corresponding to the capture screen may be displayed as shown in FIG. 10.

For example, the controller 180 may execute the map application using the name of the map application or the application server address stored to be corresponded to the selected thumbnail images.

Then, the controller 180 sequentially performs a series of user input operations stored to be corresponded to the selected thumbnail images, that is, selection of the path finding button 411, inputting of “Seoul City Hall” to the destination input window 422 using the key pad 430, and selection of an automobile button 440, and therefore the screen 401′ corresponding to the captured screen may be displayed.

The screen 401′ may be the same screen as previously captured screen, but it may be the screen updated according to current map-related information.

For example, the map screen 401 shown in FIG. 13 and the map screen 401′ shown in FIG. 10 are maps for the same region, but the traffic information is updated at this time and may be displayed differently from the past.

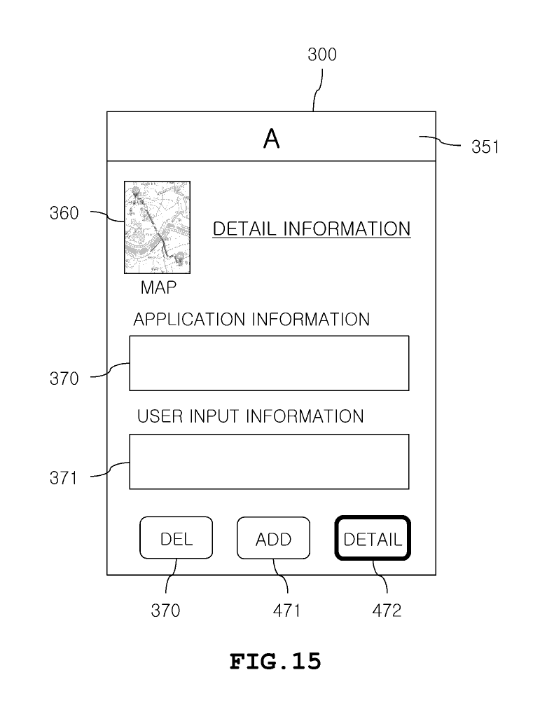

On the other hand, when the user selects a thumbnail image 360 and presses a detail information button 472 on the screen shown in FIG. 14, the application identification information and user input information related to the captured screen corresponding to the thumbnail image 360 may be displayed on an application information window 370 and a user input information window 371 respectively as shown in FIG. 15.

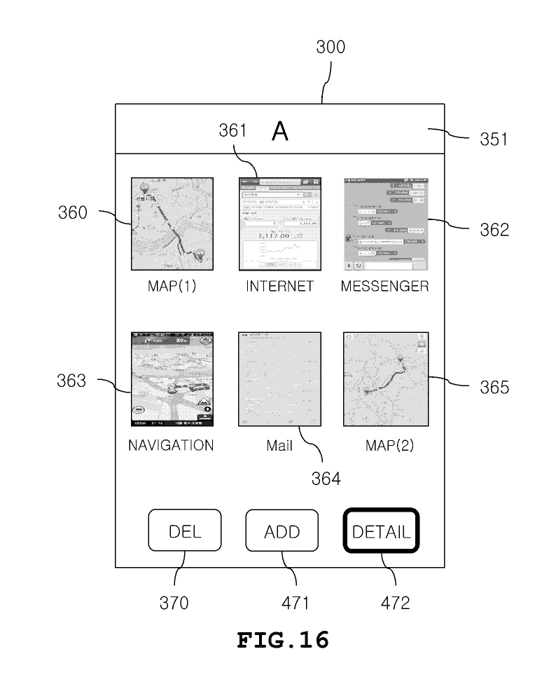

Referring to FIG. 16, when a method described above is used and the captured screen registered into the “A” application may be multiple, an initial screen of the “A” application may be displayed with thumbnail images 360 to 365 corresponding to each of the captured screen.

The plurality of capture screens may be ones for the applications different from each other, and some of them may be different captured screens for the same application.

For example, “map (1)” thumbnail image 360 and “map (2)” thumbnail image 360 are the screens to be captured on executing the same map application, but the captured time or a series of user input operations may be different from each other.

The method according to above-described present invention is manufactured with program performing in a computer and is stored to the computer-readable recording medium. Examples of the computer-readable recording medium are a ROM, a RAM, a CD-ROM, a magnetic tape, a floppy disk, an optical data storage device and the like, and may be also implemented in a type of carrier waves (for example, transmittance through Internet).

The computer-readable recording medium is distributed to the computer system connected to network, and the computer-readable code is stored in a distributed way and may be performed. Further, functional programs, codes, code segments implementing the method may be easily inferred by programmers in the art to which the present invention belongs.

According to an embodiment of the present invention, executing and input processes of the application may be automatically implemented using a captured screen of the application executed already, thereby to enhance the convenience of an application user.

According to another embodiment of the present invention, executing and input processes of the application may be automatically implemented using the captured screen of the application executed already, thereby to enhance the convenience that quickly and easily searches the functions that intuitively want through images by the user.

In addition, although the preferred embodiments of the present invention are shown and described above, the present invention is not limited to above-described specific embodiment and is variously modified by one skilled in the art without the gist of the present invention claimed in the claims, such that the modified embodiment is not to be understood separately from technical ideas or views of the present invention.

What is claimed is:

1. A method for executing an application, comprising:
capturing a screen being executed on an application; registering the captured screen together with user input information;
displaying the captured screen as thumbnail images on a certain page of the application; and
displaying the screen corresponding to the captured screen, when the displayed thumbnail images are selected, using the registered user input information.

2. The method for executing an application according to claim 1, wherein the user input information includes information for sequential inputs requested from the user in the interval from executing of the applications to displaying of the captured screen.

3. The method for executing an application according to claim 1, wherein the screen corresponding to the captured screen updates the captured screen according to the related information at this time.

4. The method for executing an application according to claim 1, further comprising receiving the identification information for the thumbnail images in response to the request of the user.

5. The method for executing an application according to claim 1, wherein the capturing includes capturing the screen of a first application being executed, the registering includes registering the captured screen, together with the identification information and user input information for the first application, into a second application, the displaying as thumbnail images includes displaying the captured screen as the thumbnail images on executing the second application, and the displaying the screen corresponding to the captured screen includes executing the first application and displaying the screen corresponding to the captured screen, when the displayed thumbnail images are selected, using the registered identification information and user input information.

6. The method for executing an application according to claim 5, wherein the identification information includes any one of a name of the first application, an application server address and manufacturer information.

7. The method for executing an application according to claim 5, wherein the user input information includes information for sequential inputs requested from the user in the interval from executing of the first application to displaying of the captured screen.

8. The method for executing an application according to claim 5, wherein the screen of the first application being executed is displayed with a selection button for registering into the second application.

9. The method for executing an application according to claim 5, wherein the screen corresponding to the captured screen updates the captured screen according to the related information at this time.

10. The method for executing an application according to claim 9, wherein when the first application is the application providing map information, the displaying the screen corresponding to the captured screen updates and displays the captured screen according to current traffic information.

11. The method for executing an application according to claim 5, further comprising displaying at least one of the registered identification information and user input information in response to the request of the user.

12. A terminal, comprising:
an output section displaying a screen of an application; and
a controller for capturing the screen being executed, registering the captured screen together with user input information, displaying the captured screen as thumbnail images on executing the application, and displaying and controlling the screen corresponding to the captured screen, when the displayed thumbnail images are selected, using the registered user input information.

13. The method for executing an application according to claim 12, wherein the user input information includes information for sequential inputs requested from the user in the interval from executing of the applications to displaying of the captured screen.

14. The method for executing an application according to claim 12, wherein the screen corresponding to the captured screen updates the captured screen according to the related information at this time.

15. The method for executing an application according to claim 12, wherein the controller captures a screen of a first application being executed, registers the captured screen, together with identification information and a user input information for the first application, into a second application, displays the captured screen as specific thumbnail images on executing the second application, and executes the first application and displays the screen corresponding to the captured screen, when the displayed specific thumbnail images are selected, using the registered identification information and user input information.

16. The method for executing an application according to claim 15, wherein the identification information includes any one of a name of the first application, an application server address and manufacturer information.

17. The method for executing an application according to claim 15, wherein the user input information includes information for sequential inputs requested from the user in the interval from executing of the applications to displaying of the captured screen.

18. The method for executing an application according to claim 15, wherein the screen corresponding to the captured screen updates the captured screen according to the related information at this time.

19. A server providing an application for performing the steps of:
capturing a screen being executed;
registering the captured screen together with user input information;
displaying the captured screen as thumbnail images on a certain page of the application; and
displaying the screen corresponding to the captured screen, when the displayed specific thumbnail images are selected, using the registered user input information.
